(19) United States
(12) Patent Application Publication
(10) Pub. No.: US 2007/0027223 A1
(43) Pub. Date: Feb. 1, 2007

(54) Foamed preparation

(76) Inventors: Werner Bruchert, Oberasbach (DE); Ursula Hunsinger, Nurnberg (DE); Georg Roder, Schwabach (DE); Willy Weiss, Altdorf (DE)

Correspondence Address: BACHMAN & LAPOINTE, P.C., 900 CHAPEL STREET, SUITE 1201, NEW HAVEN, CT, 06510, US

(21) Appl. No.: 11/495,322

(22) Filed: Jul. 27, 2006

(30) Foreign Application Priority Data
Jul. 28, 2005 (DE) 20 2005 011 885.0

(51) Int. Cl. C08J 9/00

(52) U.S. Cl. 521/50

(57) ABSTRACT

A foamed preparation which was obtained from a composition containing material in particle form, wherein the volume of the foamed preparation is increased by at least 10 times in comparison with the volume of the starting composition and wherein the composition, besides the material in particle form, contains at least one tenside and at least one thickening agent in a fluid medium.

### BACKGROUND OF THE INVENTION

The present invention concerns a foamed preparation and an apparatus suitable for foaming up a composition.

Foamed products are well-known in the field of cosmetics, more specifically in the form of shaving foam, hair setting foam, foam tinting agents with oxidation colouring agents, cleaning emulsions, sun protection agents, face masks and the like. Those foamed products can be foamed up either with compressed air or in a pressureless mode. Either aerosols containers or pump systems are used for that purpose. Thus for example EP 0 853 500 or EP 1 189 818 describe pump systems for foaming liquids which can be of low or high viscosity without compressed air.

However the aerosols systems or pump systems used hitherto for foam production were not employed to foam products which contained ingredients in particle form, in particular particles of a size of more than 200 nm. It was assumed that both systems are unsuitable as ingredients in particle form such as relatively coarse pigments, pearl pigments or plastic sequins or spangles clog the discharge devices or the particles settle and therefore do not pass into the foam at all. Further problems with aerosols arise out of the necessity to use a propellent gas. If the propellent gas is selected from compressed air, nitrogen, nitrogen monoxide or carbon dioxide, particularly pressure-resistant aerosols containers are required. Oxygen in the air and carbon dioxide can react with the ingredients of the preparation in an undesirable manner. If on the other hand inert propellent gases are selected such as propane/butane, dimethyl ether or mixtures thereof, problems also arise in regard to environmental pollution, such as VOC problems and the greenhouse effect, besides the very easy flammability of those propellent gases.

Other problems arise in the case of pressureless pump systems. The known foam applicators convey large amounts of product which are not suitable for the use intended in accordance with the invention. In relation to the compositions containing ingredients in particle form, in particular particles of a size of more 200 nm and a specific weight which is higher by a factor of at least 3 than that of water or that of the solvents which are usually employed for cosmetic products, a further problem is that the particles settle. The amount conveyed in each stroke becomes non-homogenous as a result, in particular in regard to the proportion of the ingredients in particle form. In order to avoid non-homogeneity of that kind, the material has to be thickened, which in turn has the result that a crater or cavity is formed in the pump system and that impedes conveying the material.

Therefore the object of the invention was to provide a composition which can be foamed up in spite of a proportion of ingredients in particle form. A further object of the invention was to provide a composition which remains homogenous even after being filled and upon storage thereof over a prolonged period of time and which nonetheless can be applied by way of a pump system and which leads to a homogenous, fine-foam mass. A further object of the invention was to provide a composition which can be foamed without the use of pressure in a pump system.

### SUMMARY OF THE INVENTION

The foregoing objects are attained with a foamed preparation which was obtained from a composition containing material in particle form, wherein the volume of the foamed preparation is increased by at least 10 times in comparison with the volume of the starting composition and wherein the composition, besides the material in particle form, contains at least one tenside and at least one thickening agent in a fluid medium.

### DETAILED DESCRIPTION

The subject-matter of the invention is in particular a foamed preparation which was obtained from a composition containing material in particle form, wherein the volume of the foamed preparation is increased at least by 10 times, preferably between 10 and 100 times, in comparison with the volume of the starting composition, and wherein the composition, besides the material in particle form, contains at least one tenside and at least one thickening agent in a fluid medium.

It was surprisingly found that a foamed preparation with material in particle form can be produced using a pressureless pump system if the composition used as the starting material for the foaming operation is one which contains such an amount of tenside that the volume of the foam is increased by at least 10 times. A further essential constituent is a thickening agent which gives the composition structure. It is particularly advantageous for the composition according to the invention to be foamed in a pump system which conveys only very small amounts of product and foams up same with a large amount of air. A pump system as is known for example from EP 0 853 500 or EP 1 189 818 can be used for that purpose. Preferably the system is so adjusted that amounts of product in the range of between 0.0.1 and 0.1 ml are conveyed.

According to the invention there is obtained a foam which is homogenous and at the same time so stable that upon distribution it does not immediately collapse into itself. At the same time that foam contains material in particle form, in particular effect particles such as pigments, coloured pigments, fluorescent pigments or spangles or sequins which can be applied in a very small amount by means of the foam. A further advantage of the preparation according to the invention is that, in use, only the amount of foam which is required is delivered and the content is separated from the amount delivered so that microbiological problems as occur in the case of cosmetics which are usually contained in tubes or pots do not arise.

The foamed preparation is intended for use in particular for decorative purposes in the field of cosmetics.

The subject-matter of the invention is a foamed preparation which contains a material in particle form. As pigments in widely different forms are generally incorporated into cosmetic products in the form of particles, the term “pigmented” is frequently used hereinafter and is intended to embrace any material in particle form, which can be incorporated into cosmetic preparations.

The starting composition which is foamed to afford the preparation according to the invention can be preparations which are capable of flow and which are usually employed for cosmetic compositions. Aqueous gels and organogels as well as water-in-oil or oil-in-water emulsions are appropriate. It is important that the starting composition is sufficiently capable of flow for it to be conveyed in a pump system. Emulsions are therefore very well suited both with a continuous aqueous phase and also a continuous oil phase. That kind of composition is very frequently employed in the field of cosmetics and suitable components are known to the man skilled in the art. It is also possible to use gels or oleogels if they are sufficiently capable of flow. Particularly suitable compositions are thixotropic gels or emulsions, that is to say masses which when standing form a gel-like structure but which become of low viscosity under the effect of shearing forces. The preparation of such thixotropic compositions is known to the man skilled in the art. The basic materials for emulsions and gels are water, aqueous solvents such as water-ethanol mixtures, fats, oils and waxes and further ingredients which are usual in the field of cosmetics. Emulsions generally contain emulsifiers and gels generally contain gelling agents.

As ingredients which are essential to the invention the starting composition contains a material in particle form, at least one tenside and at least one thickening agent in a fluid medium.

The composition according to the invention contains as a value-determining component a material in particle form which can be a filler, a pigment, an effect substance, a metal spangle or plastic spangle or some other material in particle form which is incorporated into cosmetic preparations. The proportion of the material in particle form depends on the nature of the material used, the desired consistency and the effect which is to be achieved therewith. Thus the proportion of the pigment depends inter alia on the desired colour and the proportion of fillers depends on the desired consistency of the material. Effect agents which can be incorporated are for example constituents which glitter, fluoresce, luminesce, phosphoresce and/or light up under long-wave UV light, referred to as black light. Particles for example which are laden with substances which are fluorescent, luminescent, phosphorescent or which produce effects in some other fashion, as are described for example in WO 2004/108108 are suitable. The amount of the material in particle form is not critical and can be in a wide range, depending on the respectively desired effect, in which respect a maximum amount can be determined by the respective cosmetic regulations in respect of some constituents. An advantage of the invention is that on the one hand material in particle form, possibly in a mixture, can be incorporated into the composition in any desired amount and can be foamed, as the material is stabilised by the structure. On the other hand the amount of effect material can be small as the material can be easily applied by virtue of the foaming thereof and only has to be present in very small proportions in order to deploy its effect.

Examples of material in particle form are fillers such as for example talc, kaolin, starch and modified starch, polytetrafluoroethylene powder (Teflon), nylon powder, boron nitride, insoluble metal soaps such as Mg stearate, Ca stearate, Sr stearate, Zn stearate and inorganic or organic pigments. The following may be mentioned by way of example for the latter: titanium dioxide, zinc oxide, iron oxides, chromium oxide, chromium hydroxide, ultramarine, Berlin Blue (Ferric Blue), carmine or the salts of carminic acid, mica, pearlescence agents such as for example mica coated with titanium dioxide, coloured mica coated with titanium dioxide and metal oxides, bismuth oxychloride, coated bismuth oxychloride, flake form metal powder of aluminium, brass, bronze, copper, silver, gold which can possibly also be coated with coloured metal oxides, so-called “glitter” in the form of thin and finely divided plastic flakes of polyester or the like immobilised colouring agents and lakes of organic colouring agents with aluminium, barium, calcium or strontium. That list is only given by way of example and is not definitive. In regard to the choice of those additives, the respective national or regional cosmetics legislation is possibly to be taken into consideration.

The amount of the solid phase preferably depends on the maximum amount which is governed by cosmetic regulations in the individual countries. Those colouring agents are selected from covering to strongly covering colouring agents of mean particle sizes of between 200 nm and 5 μm in the case of the spherical colouring agents in powder form, and from colouring agents in flake form with a mean particle size of between 5 and 145 μm, in particular between 10 and 30 μm. The above-mentioned covering to strongly covering colouring agents can be held in suspension in the pigmented cosmetic preparation sufficiently well without separation phenomena over a prolonged storage time or by the addition of suitable additives such as shaker balls or irregularly shaped shearing portions into the storage container they can be easily shaken up again and thus again homogenously incorporated into the cosmetic preparation.

The amounts used are preferably within the limits of the maximum amount allowed by the respective cosmetic regulations. In that respect the quantitative proportions of pigments are in a range of 0.1 to 20% by weight, preferably in a range of 3 to 15% by weight and quite particularly preferably in a range of 5 to 10% by weight. If the preparation according to the invention is used as a light protection agent, it is possible to add thereto, besides iron oxides as base colouring, cerium oxide, titanium dioxide and/or zinc oxide in the form of so-called nanopigments involving particle sizes in the range of between 5 and 25 nm in an amount of 1 to 10% by weight, preferably 3 to 8% by weight, optionally also in combination with usual oil-soluble UV-A and/or UV-B light filter substances which are allowed by the respective national or regional regulations. The above-mentioned quantitative proportions for the solid phase, as also in the entire description, are set forth in percent by weight in each case with respect to the finished preparation unless otherwise stated, in which respect the sum of all ingredients of the aforementioned preparation should constitute 100% by weight. The foregoing quantitative details however are not critical and the amounts involved can certainly be slightly below or above same in an individual case, in which respect nonetheless preparations according to the invention are still obtained.

The tenside contributes to increasing the volume of the composition to the desired extent. The composition therefore contains such an amount of tenside that the volume of the starting composition is increased by at least 10 times, preferably at least 25 times, in the foaming operation. It is possible to use either a tenside or a mixture of tensides. Many kinds of tensides which can be used are known in the field of cosmetics. The tenside is not to irritate skin and mucous membranes and should not detrimentally influence the other ingredients. In particular anionic, amphoteric and cationic tensides are suitable. Preferably the tenside is selected from sodium acyl glutamate, sodium lauroyl sarcosinate, sodium cocoyl sarcosinate, disodium cocoamphodiacetate, sodium lauroyl taurate, sodium methyl lauroyl taurate, sodium cocoyl-hydrolysed sweet almond protein, sodium PEG-6 cocamide caroxylate, disodium alkyl amphodiacetate, lauroamphocarboxyglycinate, palmitoamidopropyl-trimonium chloride, capryl/capramidoproyl betaine or mixtures thereof.

The tenside is used in such an amount that the volume of the starting composition is increased by at least 10 times. The amount necessary for that purpose depends on the respective tenside used and can be easily determined by the man skilled in the art. The increase in volume can be determined in per se known manner by a procedure whereby, under ambient conditions, usually 23° C.±2° C., the volume of the composition prior to foaming and the volume of the foamed preparation are determined and the increase in volume is calculated therefrom. In general a tenside content in the range of 1 to 18% by weight, preferably 5 to 15% by weight and in particular 8 to 12% by weight is suitable. In an individual case however it is also possible to use smaller amounts or also larger amounts, in dependence on the nature of the tenside.

A further essential constituent of the composition according to the invention is a thickening agent. As stated above the thickening agent serves to impart to the composition such a structure that the particles do not settle and at the same time a sufficient flow capability is maintained that the material can be conveyed. In particular those thickening agents which produce a thixotropic state in the composition are suitable. Corresponding thickening agents are well-known in the field of cosmetics. It is possible to use vegetable, organic, inorganic and synthetic substances as well as mixtures thereof. Suitable substances are for example vegetable substances such as carrageenan, xanthan gum, tragacanth, gum arabic, alginates such as agar agar and derivatised vegetable substances such as for example propylene glycol alginate; synthetic substances such as acrylate polymers with polyfunctional groups, in which respect an example is the commercially available product carbomer; inorganic thickening agents from the group of bentonites, hectorites and montmorillonites as well as derivatives thereof such as for example quaternium-18-bentonite or quaternium-18-hectorite. Mixtures of the said substances can also be used. The thickening agent or agents are used in such an amount that the desired structure is produced. A suitable amount to be used is in the range of from 0.1 to 6% by weight, preferably from 0.5 to 4% by weight and quite particularly preferably from 1.0 to 1.5% by weight, in each case in dependence on the thickening agent used.

The amount of thickening agent also depends on the viscosity desired for the intended product. It has been found that compositions can be foamed well when they are of a viscosity in the range of 0.5 to 40, preferably from 1 to 20 Pa·s and particularly preferably from 3 to 8 Pa·s. The viscosity is determined at 6 rpm in a commercially available viscosimeter with a plate/plate measuring device of 20 mm diameter with a plate spacing of 400 μm at 23+/−2° C.

The thickening agent is selected in dependence on the nature of the base formulation, in particular the nature of the phase to be thickened. Suitable thickening agents for oily and aqueous phases are well-known to the man skilled in the art and the amount suitable for setting a desired viscosity can be found out in a few tests.

The preparation according to the invention can contain further ingredients which are suitable and known for producing desired properties.

In order to prevent the preparation according to the invention from being quickly drawn into the skin and thereby to guarantee better distributability at the place of application, polyols with two or more alcohol functions are advantageously added thereto. The following are mentioned by way of example in this respect: 1,2-propylene glycol, dipropylene glycol, glycerin, diglycerin, triglycerin, butylene glycols (butane-1,2-, -1,3- or -1,4-diol), trimethyl pentane diol, hexylene glycols (hexane-1,2-, -1,3-, -1,4- or -1,6-diol), polyethylene glycols of molecular weights in the range of from 200 to 2,000 Daltons, monosaccharides, such as for example xylose, glucose, mannose, galactose, fructose or sorbose, disaccharides such as saccharose (sucrose), lactose, maltose, trehalose, cellobiose, oligosaccharides such as for example raffinose, the polyols which can be obtained therefrom by hydration such as for example sorbitol, mannitol or xylitol, polysaccharides such as hyaluronic acid or chitosan, hydroxy acids, in particular α-hydroxy acids or β-hydroxy acids and their salts such as for example lactic acid and/or lactates (sodium lactate, ammonium lactate), malic acid and/or malates, citric acid and/or citrates, tartaric acid and/or tartrates, pyrrolidone carboxylic acid and/or its salts, in particular the sodium salt, urea and mixtures of the aforesaid substances.

In that respect 1,2-propylene glycol, glycerin, sorbitol, mannitol, sodium pyrrolidone carboxylate and mixtures thereof are preferred. A suitable amount of polyols to be used in the preparation according to the invention is in the range of from 1 to 12% by weight, preferably between 2 and 8% by weight and particularly preferably between 3 and 6% by weight. Particularly preferably 1,2-propylene glycol and glycerin are used.

The preparation according to the invention can advantageously also include further usual ingredients such as for example W/O or O/W emulsifiers, fats, oils, fatty alcohols, fatty acids and waxes which are of vegetable, animal, mineral or synthetic origin, fillers and powder raw substances, complex-forming agents, preserving agents, antioxidants, self-tanning agents such as for example dihydroxy acetone or ninhydrin or mixtures thereof, light protection agents (water-soluble and/or lipid-soluble UV-A and UV-B filters), usual plant extracts and other cosmetic active substances, colouring agents and mixtures of said substances.

The following are mentioned by way of example as W/o emulsifiers: sorbitan laurate, sorbitan palmitate, sorbitan stearate, sorbitan tristearate, sorbitan oleate, sorbitan trioleate, glycerin sorbitan fatty acid ester, PEG-7 hydrated castor oil, trioleyl phosphate, trilanath-4-phosphate or mixtures thereof. O/W emulsifiers are to be selected for example from PEG-30 stearate, PEG-40 sorbitan peroleate, ceteareth-10, ceteareth-20, ceteareth-30, PEG-24 glyceryl stearate, laureth-23, oleth-20, oleth-30, steareth-20, glycerin monostearate self-emulsifying or mixtures thereof.

Suitable fats and oils and other lipid substances are to be found for example among hydrated vegetable oils, coconut oil, coco butter, shea butter, PPG-5-laureth-5, isooctyl stearate, isopropyl myristate, butyl stearate, isopropyl isostearate, isostearyl isostearate, ethylhexyl dodecanol, capryl/capric acid triglyceride, paraffin oils, volatile or non-volatile silicone oils or mixtures thereof.

Suitable fatty alcohols, fatty acids or waxes are cetyl alcohol, stearyl alcohol, behenyl alcohol or mixtures thereof, palmitic acid, stearic acid, behenic acid, mellissic acid or mixtures thereof, oleyl erucate, jojoba oil, hydrated jojoba oil, cetyl palmitate, myristyl myristate, stearyl stearate, behenyl behenate, Japan wax, beeswax, paraffin waxes, microcrystalline waxes, ozocerite, montan wax, flower waxes, fruit waxes or mixtures of the said substances.

In accordance with the invention that starting composition can be foamed up using a pressureless system. The use of a pressureless system is advantageous as stated above. The composition however is also suitable for foaming up with an aerosol system. Usually the foaming-up operation is effected with ambient air. For specific uses however it is also possible to employ an inert gas or protective gas for the foaming operation. In that case gases to be considered are carbon dioxide, nitrogen, noble gases such as argon or neon or a mixture of those gases. A protective gas is used in particular when oxidation-sensitive ingredients are included in the composition.

A further subject-matter of the invention is therefore an apparatus for pressureless production of foam comprising a container and a metering device having a spray head, wherein the container contains a composition which has material in particle form, at least one tenside and at least one thickening agent in a fluid medium, wherein the composition is preferably of a viscosity of the range of 1 to 20 Pa·s and can be foamed up to afford a preparation whose volume is increased by at least 10 times in comparison with the starting material.

The apparatus according to the invention can be used to produce a foamed preparation which contains material in particle form, which furnishes a very fine foam, which can be easily applied and which can be used for decorative cosmetics.

Preferably the apparatus has a metering device which conveys only 0.05 to 0.1 ml per stroke. Conveying a very small amount and supplying a large amount of gas, in particular air, produces a very strongly foamed, high-volume, fine-pore foam.

The container which contains the composition to be foamed is preferably of a volume which is small in comparison with known apparatuses, in the range of 10 to 20 ml.

In a preferred embodiment the apparatus is so designed that the ambient air serves as gas for the foaming operation. Apparatuses suitable for that purpose are well-known to the man skilled in the art. In another embodiment the apparatus is so designed that an inert or protective gas is used for the foaming operation. In that case the apparatus has a gas-containing chamber.

A further subject-matter of the invention is a process for producing a foamed preparation from a composition, as was described hereinbefore, wherein the composition has a material in particle form, at least one tenside, at least one thickening agent and a medium capable of flow, wherein said starting composition is foamed up with a gas so that the volume is increased by at least 10 times. Preferably the volume is increased to 10 to 100 times.

The foamed preparation according to the invention serves in particular for use in decorative cosmetics. It is preferably employed as makeup, foundation, concealer, rouge, eyeshadow or effect cream.

The preparation according to the invention is described in greater detail hereinafter by means of examples without thereby restricting the preparation. The raw materials referred to in the examples are identified by the “INCI” names (International Nomenclature of Cosmetic Ingredients) which are usually employed in the field of cosmetics. The amounts specified are in parts by weight.

Example 1 (foam makeup)

| | |
|---|---|
| Aqua (freshly distilled) | 74.100 |
| Carrageenan | 1.500 |
| Propylene glycol alginate | 1.300 |
| Glycerin | 4.000 |
| Sodium lauroyl sarcosinate | 5.000 |
| Disodium cocoamphodiacetate | 3.500 |
| Sodium cocoyl hydrolysed sweet almond protein | 4.500 |
| Red iron oxide (CI No 77.491) | 0.750 |
| Yellow iron oxide (CI No 77.492) | 1.200 |
| Black iron oxide (CI No 77.499) | 0.250 |
| Titanium dioxide (CI No 77.981) | 2.800 |
| Phenoxyethanol | 0.650 |
| Methylparaben | 0.200 |
| Ethylparaben | 0.050 |
| Propylparaben | 0.075 |
| Butylparaben | 0.025 |
| α-Tocopherol | 0.100 |

For the production procedure approximately a third of the amount of water is heated to about 65-70° C. in a suitable vessel, then the carrageenan and the propylene glycol alginate are dissolved lump-free therein with agitation with a propeller agitator. The mixture is allowed to cool down and in the cooling phase glycerin, sodium lauroyl sarcosinate, disodium cocoamphodiacetate and sodium cocoyl hydrolysed sweet almond protein are added and the mixture is agitated—as far as possible without major air inclusions—until smooth. The parabens and the α-tocopherol are then dissolved in the phenoxyethanol and that mixture is added to the overall mixture. The pigments are dispersed in about four times the amount of water and passed three times through a three-roll mill. The pigment mixture is then added to the overall mixture. The mixture is then transferred into a vacuum process installation, it is heated to about 35° C. and the amount of water which is still left is added to the mixture. The mixture is now agitated under vacuum until smooth and then completely deaerated. The result obtained is a skin-coloured, pasty mixture of a viscosity of 4,500 MPa·s, measured at 23° C.±2° C. and with 6 rpm with a commercially available viscosimeter with a plate/plate measuring device of 20 mm diameter, at a plate spacing of 400 μm, which can be well foamed up and distributed very well and uniformly on the skin, with the above-outlined foam applicator.

Example 2 (foam makeup for the evening)

| | |
|---|---|
| Aqua (freshly distilled) | 69.050 |
| Carrageenan | 1.500 |
| Propylene glycol alginate | 1.300 |
| 1,3-Butylene glycol | 3.200 |
| Sodium PCA | 0.750 |
| Sodium lactate | 0.250 |
| PEG-7 Glyceryl cocoate | 1.700 |
| Sodium lauroyl taurate | 5.500 |
| Sodium PEG-6 cocamide carboxylate | 3.500 |
| Sodium cocoyl hydrolysed sweet almond protein | 4.500 |
| Sodium hyaluronate | 0.150 |
| Mica and titanium dioxide and iron oxides | 6.000 |
| (CI No 77.891 and CI No 77.491 and CI No 77.492) | |
| Red iron oxide (CI No 77.491) | 0.150 |
| Yellow iron oxide (CI No 77.492) | 0.450 |
| Black iron oxide (CI No 77.499) | 0.050 |
| Titanium dioxide (CI No 77.981) | 0.550 |
| Quaternium-18-hectorite | 0.300 |
| Phenoxyethanol | 0.650 |
| Methylparaben | 0.200 |
| Ethylparaben | 0.050 |
| Propylparaben | 0.075 |
| Butylparaben | 0.025 |
| α-Tocopherol | 0.100 |

Production is effected in a substantially similar fashion to example 1 but in this case the pearl pigment is not passed by way of a three-roll mill but only added to the mixture after transfer into the vacuum process installation and homogenously incorporated by means of the agitator device provided there. It is particularly advantageous in that respect for a particularly coarse-particle pearl pigment involving particle sizes of the range of from about 80 to 150 μm to be selected at least in part. The result obtained is a bronze-coloured, weakly covering and strongly shiny pasty mixture of a viscosity of 5,700 mP·as, measured as indicated above, which can be well foamed with the above-outlined foam applicator and which can be very well and uniformly distributed on the skin and which is suitable in particular for shading the cheeks and for decoration of the décolletage.

Example 3 (foam rouge)

| | |
|---|---|
| Aqua (freshly distilled) | 67.250 |
| Tragacanth gum | 1.500 |
| Propylene glycol alginate | 1.300 |
| 1,2-Hexylene glycol | 3.500 |
| Sodium PCA | 0.500 |
| PEG-7 Glyceryl cocoate | 1.700 |
| Sodium lauroyl sarcosinate | 5.000 |
| Sodium PEG-6 cocamide carboxylate | 4.500 |
| Sodium cocoyl hydrolysed sweet almond protein | 4.500 |
| Sodium hyaluronate | 0.100 |
| Mica (CI No 77.891) | 4.500 |
| Red iron oxide (CI No 77.491) | 2.500 |
| Yellow iron oxide (CI No 77.492) | 0.250 |
| Black iron oxide (CI No 77.499) | 0.150 |
| Titanium dioxide (CI No 77.981) | 1.350 |
| Quaternium-18-hectorite | 0.300 |
| Phenoxyethanol | 0.650 |
| Methylparaben | 0.200 |
| Ethylparaben | 0.050 |
| Propylparaben | 0.075 |
| Butylparaben | 0.025 |
| α-Tocopherol | 0.100 |

Production is effected in a substantially similar fashion to example 2, in this case once again the pearl pigment is not passed by way of a three-roll mill but only added to the mixture after transfer into the vacuum process installation and homogenously incorporated by means of the agitator device provided there. The result obtained is a vermilion, weakly covering and matt-shiny pasty mixture of a viscosity of 3,800 mp·as measured as described above, which foams well with the above-outlined foam applicator and which can be very well and uniformly distributed on the skin and which is suitable in particular for shading the cheeks.

Example 4 (foamed sun protection agent, W/O emulsion)

| | | |
|---|---|---|
| (1) | Aqua (freshly distilled) | 39.600 |
| | Xanthan gum | 0.500 |
| | 1,2-Propylene glycol | 4.500 |
| | Sodium PCA | 0.500 |
| | PEG-7 Glyceryl cocoate | 1.700 |
| | Octyldodecanol | 1.500 |
| | Ceteareth-20 | 1.800 |
| | Ethylhexyl methoxycinnamate | 3.000 |
| | Benzophenone-3 | 2.500 |
| (2) | Titanium dioxide, nanopigment (CI No 77.981) | 5.500 |
| | Red iron oxide (CI No 77.491) | 0.450 |
| | Yellow iron oxide (CI No 77.492) | 0.200 |
| | Black iron oxide (CI No 77.499) | 0.150 |
| | Titanium dioxide (CI No 77.981) | 0.300 |
| (1) | Aqua (freshly distilled) | 25.000 |
| | Sodium lauroyl sarcosinate | 5.000 |
| | Sodium cocoyl hydrolysed sweet almond protein | 4.500 |
| | Sodium phenylbenzimidazole sulphonate | 2.500 |
| (4) | Phenoxyethanol | 0.650 |
| | Methylparaben | 0.200 |
| | Ethylparaben | 0.050 |
| | Propylparaben | 0.075 |
| | Butylparaben | 0.025 |
| | α-Tocopherol | 0.100 |
| | Fragrance | 0.200 |

For production purposes the water is heated in a vacuum process installation to 70° C., then the xanthan is dissolved in clump-free fashion therein and then the propylene glycol and the sodium PCA are added. The other constituents of phase (1) are also heated to 70° C. and added to the water phase and processed under a slight vacuum to give an O/W emulsion. It is allowed to cool down to about 40° C., then the titanium dioxide (nanopigment of a mean particle size of between 5 and 20 nm) is added together with the remaining colouring agents and homogenisation is again effected for a short time. The water is provided in a separate vessel and now the other constituents of phase (3) and the phase (4) are stirred thereinto. That water phase is now added to the previously produced O/W emulsion, thorough mixing is effected with the agitator device, homogenisation is effected once again for a short time and then the batch is deaerated. The pH-value is adjusted to 7.1 to 7.3 in the usual manner. The result obtained is an O/W emulsion which can be well foamed by means of a foam applicator and which has a weakly covering action on the skin and which is approximately skin-coloured and which can be very well distributed, being in the form of a semi-liquid skin lotion of a viscosity of 5,200 mP·as measured as indicated above. It provides protection both against UV-A and UV-B and has a light protection factor in the region around SF 25.

Example 5 (foamed effect hair colour, O/W emulsion)

| | | |
|---|---|---|
| (1) | Aqua (freshly distilled) | 39.050 |
| | Xanthan gum | 0.500 |
| | Quaternium-18 hectorite | 0.300 |
| | 1,2-Propylene glycol | 4.500 |
| | PEG-7 Glyceryl cocoate | 3.700 |
| | Octyldodecanol | 1.500 |
| | Ceteareth-20 | 1.800 |
| | Cetearyl alcohol | 2.000 |
| | Palmitoamidopropyltrimonium chloride | 2.500 |
| (2) | Aqua (freshly distilled) | 25.000 |
| | Disodium distyryl biphenyl disulphonate | 0.350 |
| | Sodium lauroyl sarcosinate | 1.500 |
| | Lauroamphocarboxy glycinate | 3.000 |
| | Sodium cocoyl hydrolysed sweet almond protein | 4.500 |
| (3) | Polyester-3, Yellow 11 | 6.000 |
| | Polyester-3, Blue 1 | 3.000 |
| (4) | Phenoxyethanol | 0.650 |
| | Methylparaben | 0.200 |
| | Ethylparaben | 0.050 |
| | Propylparaben | 0.075 |
| | Butylparaben | 0.025 |
| | α-Tocopherol | 0.100 |
| | Fragrance | 0.200 |

For the production process the water is put in a vacuum process installation, then xanthan gum and quaternium-18 hectorite are added and agitation is effected to produce a smooth lump-free mixture and that mixture is heated to 70° C. The other constituents of phase (1) are heated together to 70° C., added to the water phase and homogenised under a slight vacuum for a short time and processed to afford a cationic O/W emulsion. The pigments of phase (3) are then scattered therein and well incorporated by homogenisation. The mixture is then cooled down to about 40° C. In a separate vessel the constituents of phase (2) are mixed together, the constituents of phase (4) are dissolved in the phenoxyethanol and the solution is added to the mixture of phase (2). Homogenisation is effected vigorously once again under maximum vacuum and the batch is deaerated. The pH-value is adjusted to 7.2 to 7.5 in the usual manner. The result obtained is a radiant green, slightly pasty preparation which has a good covering effect, of a viscosity of 4,200 mP·as measured as described above, which can be well foamed by means of a foam applicator and which can be incorporated into the hair by means of a coarse comb or the like in the form of strands and adheres firmly there. In long-wave UV light (so-called “black light”), the mixture affords intensively light-blue fluorescence.

1. A foamed preparation obtained from a composition containing material in particle form, wherein the volume of the foamed preparation is increased by at least 10 times in comparison with the volume of the starting composition and wherein the composition, besides the material in particle form, comprises at least one tenside and at least one thickening agent in a fluid medium.

2. A foamed preparation according to claim 1, wherein the starting composition is selected from the group consisting of a gel, oleogel, a water-in-oil emulsion, and an oil-in-water emulsion.

3. A foamed preparation according to claim 1, wherein the starting composition is an aqueous gel.

4. A foamed preparation according to claim 1, wherein the tenside is contained in the starting composition in such an amount that after the foaming operation the volume of the preparation is 10 to 100 times greater than the volume of the starting composition.

5. A foamed preparation according to claim 1, wherein the composition contains 1-18% by weight of tenside.

6. A foamed preparation according to claim 5, wherein the composition at least one tenside is selected from the group consisting of anionic, amphoteric, cationic tensides and mixtures thereof.

7. A foamed preparation according to claim 5, wherein the at least one tenside is selected from the group consisting of sodium acyl glutamate, sodium lauroyl sarcosinate, sodium cocoyl sarcosinate, disodium cocoamphodiacetate, sodium lauroyl taurate, sodium methyl lauroyl taurate, sodium cocoyl-hydrolysed sweet almond protein, sodium PEG-6 cocamide caroxylate, disodium alkyl amphodiacetate, lauroamphocarboxyglycinate, palmitoamidopropyltrimonium chloride, capryl/capramidoproyl betaine and mixtures thereof.

8. A foamed preparation according to claim 1, wherein the composition contains 0.1 to 6% by weight of thickening agent.

9. A foamed preparation according to claim 8, wherein the thickening agent is selected from the group consisting of vegetable, synthetic, inorganic thickening agent and mixtures thereof.

10. A foamed preparation according to claim 8, wherein the thickening agent is selected from the group consisting of carrageenan, xanthan gum, gum arabic, tragacanth, alginates, acrylate polymers with polyfunctional groups, bentonites, hectorites, montmorillonites, and mixtures thereof.

11. A foamed preparation according to claim 1, wherein the composition additionally contains at least one polyol having at least two alcohol functions.

12. A foamed preparation according to claim 1, wherein the composition contains at least one compound is selected from the group consisting of 1,2-propylene glycol, dipropylene glycol, glycerin, diglycerin, triglycerin, butane-1,2-, -1,3- or -1,4-diol, trimethyl pentane diol, hexane-1,2-, -1,3-, -1,4- or -1,6-diol, polyethylene glycol of a molecular weight in the range of 200 to 2,000 Daltons, a monosaccharide, disaccharide or oligosaccharide, polysaccharide or a hydroxy acid or polyhydroxy acid and mixtures thereof.

13. A foamed preparation according to claim 1, wherein the composition additionally contains W/O or O/W emulsifiers, fats, oils, fatty alcohols, fatty acids and waxes, fillers and powder raw materials, complex-forming agents, preserving agents, antioxidants, self-tanning agents, light protection agents, plant extracts, colouring agents and mixtures thereof.

14. A foamed preparation according to claim 1, wherein the composition container is an aqueous solvent.

15. A foamed preparation according to claim 14, wherein the solvent is water.

16. A foamed preparation according to claim 1, wherein the composition contains at least one material in particle form, the particle size of which is in the range of 50 to 200 μm.

17. A foamed preparation according to claim 16, wherein at least one pigment is the material in particle form.

18. A foamed preparation according to claim 1, wherein the preparation is obtained by pressureless foaming.

19. A foamed preparation according to claim 1, wherein the composition further comprises pigments, pearl pigments, plastic spangles and/or metal powder as the material in particle form.

20. A foamed preparation which can be obtained from a composition comprises a material in particle form, wherein the composition containing a material in particle form and comprises at least one tenside, at least one thickening agent and at least one solvent, wherein the starting composition is foamed up with a gas so that the volume is increased by 10 to 100 times.

21. Apparatus for the pressureless production of foam comprising a container and a metering device having a spray head, wherein the container contains a composition which has at least one tenside, at least one thickening agent in a solvent, wherein the composition is of a viscosity in the range of 1 to 10 Pa·s and can be foamed up to afford a preparation whose volume is increased by 10 to 100 times in comparison with the starting material.

22. Apparatus according to claim 21, wherein the metering device conveys 0.05 to 0.1 ml per stroke.

23. Apparatus according to claim 21, wherein the container is of a volume of 10 to 20 ml.
